(19) United States
(12) Patent Application Publication
(10) Pub. No.: US 2022/0224467 A1
(43) Pub. Date: Jul. 14, 2022

(54) METHOD AND APPARATUS FOR WIRELESS COMMUNICATION WITH PHASE CONTINUITY

(71) Applicant: Sierra Wireless, Inc., Richmond (CA)

(72) Inventors: Gustav Gerald Vos, Surrey (CA); James Cohen, Vancouver (CA)

(21) Appl. No.: 17/570,617

(22) Filed: Jan. 7, 2022

Related U.S. Application Data
(60) Provisional application No. 63/135,296, filed on Jan. 8, 2021.

(51) Int. Cl. H04L 5/00; H04W 72/04; H04W 72/12

(52) U.S. Cl. CPC H04L 5/0039; H04L 5/0005; H04W 72/1257; H04W 72/044

(57) ABSTRACT

There is provided methods and apparatuses for wireless communication with phase continuity. According to embodiments, a receiving device (e.g. a base transceiver station (BTS), next generation NodeB (gNodeB or gNB)) sends, to a transmitting device (e.g. user equipment (UE)), a request for transmitting data across multiple slots with phase continuity. The transmitting device transmits to the receiving device the data across multiple slots, wherein the transmitting device maintains phase continuity while the data is transmitted. In some embodiments, the receiving device is provided with capability information indicative of whether the transmitting device supports phase continuity during data transmission. In some embodiments, the receiving device determines if the transmitting device has the capability for supporting phase continuity during data transmission. In some embodiments, the receiving device notifies the transmitting device of time duration that the receiving device expects the phase to be continuous.

### CROSS-REFERENCE TO RELATED APPLICATIONS

This application claims the benefit and priority from U.S. Provisional Patent Application No. 63/135,296 filed Jan. 8, 2021, the contents of which are incorporated herein by reference in their entirety.

### FIELD

The present disclosure pertains in general to wireless communication and in particular to a method and apparatus for wireless communication with phase continuity.

### BACKGROUND

It is a challenging task to provide good cellular coverage in wireless communication systems, especially for uplink (UL) data transmission in higher frequency bands. As is well known in the industry, the performance of the wireless communication systems can be affected by channel estimation. For example, channel estimation is used by wireless transceivers for demodulating the received data and for timing tracking. As such, poor or inaccurate channel estimation can substantially degrade the wireless communication system performance. Therefore, efforts have been made to achieve high channel estimation accuracy.

One known technique to improve channel estimation is to average pilot symbols over time and frequency. This technique is typically referred to as cross-slot channel estimation or joint channel estimation. Cross-slot channel estimation can improve the channel estimation thereby enhancing wireless communication system performance. Using cross-slot channel estimation, system performance can be significantly improved in the range of 1 to 3 dB gain in various simulations.

However, cross-slot channel estimation does not always improve the performance of wireless communication systems. In fact, while depending on many factors, use of cross-slot channel estimation can degrade the wireless communication system performance. For example, cross-slot channel estimation may degrade the performance when the residual carrier frequency offset (CFO) or Doppler frequency is high such that the phase of the transmitter rotates during the averaging. Also, cross-slot channel estimation may degrade the performance when the phase continuity is not maintained by the transmitter during the period of averaging.

Generally, high CFO and/or high Doppler frequency may not be significant issues with regard to the wireless communication system performance as long as averaging pilot symbols is completed within a short period of time, for example, within 10 ms. Phase continuity should be maintained by the transmitter during the period of averaging, as the cross-slot channel estimation cannot be used unless the receiver can rely on the phase continuity during the transmission. However, phase continuity may not be maintained for various reasons such as, but not limited to, transmission power changes and transmission frequency changes during transmission.

Therefore, there is a need for a method and apparatus for wireless communication with phase continuity that is not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method and apparatus for wireless communication with phase continuity. In accordance with embodiments of the present disclosure, there is provided a method for wireless communication with phase continuity. The method includes receiving, by a transmitting device from a receiving device, a request for transmitting data across multiple slots with phase continuity. The method further includes transmitting, by the transmitting device to the receiving device, the data across multiple slots, wherein the transmitting device maintains phase continuity while the data is transmitted.

In some embodiments, the method further includes providing capability information to the receiving device. The capability information being indicative of the capability of the transmitting device for supporting phase continuity during data transmission.

In some embodiments, the capability information depends on system configuration information, wherein the system configuration information includes one or more of duplexing information, frequency bands information, time division duplex (TDD) configuration, system bandwidth information and broadcast system information. In some embodiments, the capability information is provided to the receiving device before transmitting (by the receiving device) the request for transmitting data across multiple slots with phase continuity. In some embodiments, the capability information is provided to the receiving device during an initial access procedure. In some embodiments, the capability information is provided to the receiving device as a bit mask. In some embodiments, the capability information further indicates one or more of a maximum time that the transmitting device supports phase continuity, a maximum frequency hopping distance, whether intermittent data transmission is supported, whether phase continuity is supported for uplink (UL) data channels, and whether phase continuity is supported for UL control channels.

In some embodiments, the method further includes receiving, by the transmitting device from the receiving device, a time duration for which phase continuity is expected.

In some embodiments, during transmission of the data across multiple slots, the transmitting device refrains from adjusting one or more of phase, power, frequency and timing. In some embodiments, the transmitting device maintains a phase and an amplitude during transmission of the data. In some embodiments, the request for transmitting data with phase continuity is sent during higher layer signalling.

In accordance with embodiments of the present disclosure, there is provided a transmitting device for wireless communication with phase continuity. The transmitting device includes a processor and machine readable memory storing machine executable instructions. The machine executable instructions, when executed by the processor configure the transmitting device to perform one or more of the above methods.

In accordance with embodiments of the present disclosure, there is provided a method for wireless communication with phase continuity. The method includes sending, by a receiving device to the transmitting device, a request for transmitting data across multiple slots with phase continuity. The method further includes receiving, by the receiving device from the transmitting device, the data across multiple slots, wherein the transmitting device maintains phase continuity while the data is transmitted.

In some embodiments, the method further includes autonomously determining, by the receiving device, if the transmitting device has the capability for supporting phase continuity during data transmission.

In some embodiments, the method further includes determining, by the receiving device, if the transmitting device has the capability for supporting phase continuity during data transmission at least in part based on one or more channel estimations, the one or more channel estimations performed by the receiving device across one or more slots using a single-slot channel estimation, a cross-slot channel estimation or a combination thereof.

In accordance with embodiments of the present disclosure, there is provided a receiving device for wireless communication with phase continuity. The receiving device includes a processor and machine readable memory storing machine executable instructions. The machine executable instructions, when executed by the processor configure the receiving device to perform the above method.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 illustrates error rates when transmitting transport blocks using cross-slot channel estimation under various signal-to-noise ratios (SNRs), in accordance with embodiments of the present disclosure.

FIG. 2 illustrates error rates when transmitting transport blocks with frequency hopping using cross-slot channel estimation under various signal-to-noise ratios (SNRs), in accordance with embodiments of the present disclosure.

FIG. 3A illustrates a method for wireless communication with phase continuity, in accordance with embodiments of the present disclosure.

FIG. 3B illustrates a method for wireless communication with phase continuity, in accordance with embodiments of the present disclosure.

FIG. 4 is a schematic diagram of an electronic device according to embodiments of the present disclosure.

It will be noted that throughout the appended drawings, like features are identified by like reference numerals.

### DETAILED DESCRIPTION

In order to improve the performance of wireless communication systems, use of cross-slot channel estimation is desired. However, cross-slot channel estimation may degrade the performance, especially when phase continuity is not maintained by the transmitting device during the period of averaging. Phase continuity should be maintained by the transmitting device during the period of averaging, as the cross-slot channel estimation cannot be used unless the receiving device can rely on the phase continuity during the transmission.

Phase continuity may not be maintained for several reasons. For example, phase continuity may not be maintained if there is, during transmission, one or more of a transmission power change, a transmission frequency change, a timing adjustment (e.g. timing is advanced or retarded) and reference crystal (XTAL) oscillator drift. However, depending on the wireless communication device's architecture, algorithms and/or type of transmission, phase continuity may be maintained despite there being a transmission power change, transmission frequency change, timing adjustment or XTAL oscillator drift, during transmission. For example, even if frequency hopping requires the wireless communication device to transmit transport blocks at different frequencies (i.e. transmission frequency change during transmission), a phase discontinuity may not occur depending on the architecture of the wireless communication device. As another example, the capability of maintaining phase continuity may depend on whether the synthesizer is re-tuned during transmission between the receiving device and the transmitting device in a time division duplex (TDD) system. The synthesizer may or may not be re-tuned based on the number of synthesizers used in the wireless communication device (e.g. one or multiple synthesizers).

The present disclosure provides methods and apparatuses for wireless communication with phase continuity. According to embodiments, a receiving device (e.g. a base transceiver station (BTS), evolved NodeB (eNB), next generation NodeB (gNodeB or gNB)) sends, to a transmitting device (e.g. user equipment (UE)), a request for transmitting data across multiple slots with phase continuity.

In some embodiments, the receiving device determines if the transmitting device has the capability for supporting phase continuity during data transmission. The determination of whether the transmitting device supports phase continuity can be based on capability information that is provided to the receiving device, for example by the transmitting device, wherein it is this capability information that is indicative of whether the transmitting device supports (or has capability to support) phase continuity during data transmission.

In some embodiments, the receiving device autonomously or independently determines whether a transmitting device supports or has capability to support phase continuity during data transmission (e.g. UE capability for data transmission with phase continuity).

In some embodiments, the receiving device determines whether a transmitting device supports phase continuity based on one or more channel estimations (and the decoding associated therewith), which are performed by the receiving device. These one or more channel estimations can include one or more of single-slot estimation and cross-slot channel estimation. In some embodiments, the one or more channel estimations can be associated with decoding.

According to embodiments, the transmitting device (e.g. the UE) receives from a receiving device (e.g. the base transceiver station (BTS), next generation NodeB (gNodeB or gNB)) a request for transmitting, for example data or transport blocks, across multiple slots. For example, the request can relate to transmission of repeats of data or transport blocks that are transmitted on the physical uplink shared channel (PUSCH) or the physical uplink control channel (PUCCH)). In various embodiments, the transmitting device receives a request for transmitting, for example data or transport blocks, across multiple slots with phase continuity, namely the request indicates that the transmission of data is to be made such that the phase is constant. The transmitting device receives the above-mentioned request from the receiving device in one or more of the radio resource control (RRC) signalling messages or higher level signalling. For example, higher level signalling can be configured as one or more of a RRC configuration message, a RRC reconfiguration message, an UL grant message or other higher level signalling as would be readily understood by a worker skilled in the art. In various embodiments, the transmitting device can ensure that the phase is constant during transmission. In some embodiments, the transmitting device can maintain phase continuity during transmission by mitigating or avoiding adjustments. For example, the transmitting device mitigates or avoids any adjustments relating to time advancing or time retarding. In some embodiments, the transmitting device can maintain phase continuity during transmission by not controlling transmission power, e.g., not doing the open loop power control. In some embodiments, when the transmitting device avoids performing open loop power control or avoids changing or adjusting the transmission power, the transmitting device can maintain the phase as well as the amplitude of the transmission. For example, this can be performed when quadrature amplitude modulation (QAM) is used (e.g., 64 QAM or other QAM configuration) for continuity during data transmission. In some embodiments, the receiving device notifies the transmitting device of the desired time period when phase continuity is desired (i.e. time duration that the receiving device expects the phase to be continuous). In other words, the amount of time that the receiving device (e.g. gNB) expects the phase to be continuous can be signalled to the transmitting device (e.g. UE). The notification for the time duration that the receiving device expects the phase to be continuous may be conveyed via radio resource control (RRC) signaling or in other embodiments is a more dynamic for example via a UL grant.

According to some embodiments, the receiving device determines whether the transmitting device supports phase continuity. The transmitting device may provide information (for example capability information) indicative of whether it is capable of supporting phase continuity during data transmission, for example information defining the UE's capability for transmission with phase continuity. Further, based on the information provided by the transmitting device, the receiving device would be able to identify or determine whether the receiving device can or cannot use cross-slot channel estimation while decoding or demodulating the data received from the transmitting device. It is noted that a person skilled in the art would readily understand how the information indicative of whether a transmitting device supports phase continuity is sent from the transmitting device to the receiving device. As a non-limiting example, in long-term evolution (LTE) or new radio (NR) networks, the information indicative of whether a transmitting device supports phase continuity during data transmission can be conveyed during the initial access procedure through the physical uplink shared channel (PUSCH), for example radio resource control (RRC) connection setup complete message.

In some embodiments, as stated above, the information indicative of whether a transmitting device supports phase continuity during data transmission can be conveyed during the initial access procedure (for example conveyed in message 1 (msg 1) or message 3 (msg 3) or other initial access procedure message). In order to minimize overhead, the format of the information indicative of whether a transmitting device supports phase continuity during data transmission can optionally take the form of a bit mask. In some embodiments, the information may optionally be sent with other capability information which can be also sent in the form of a bit mask. In some embodiments, the transmitting device can also determine if it can support phase continuity based on the system configuration information. As a non-limiting example, the system configuration information can include information relating to duplexing, frequency bands, time division duplex (TDD) configuration, system bandwidth, broadcast system information or other suitable system configuration information as would be readily understood.

In various embodiments, the information indicative of whether the transmitting device supports phase continuity during data transmission further indicates the maximum time duration that phase continuity can be supported by the transmitting device. This maximum time duration indicates the maximum amount of time that the transmitting device (e.g. UE) can maintain phase continuity, subject to one or more phase continuity requirements. Furthermore, provided that, as stated above, phase continuity may not be maintained if there is a transmission power change during transmission, the maximum time duration can further indicate the maximum amount of time that the transmitting device (e.g. UE) can maintain power consistency, subject to one or more power consistency requirements. Based on the maximum time duration, which indicates the maximum time duration that the transmitting device (e.g. UE) can maintain (transmitting) power consistency and phase continuity, the receiving device (e.g. gNB) can identify or determine the maximum time duration that the receiving device can use cross-slot channel estimation. The maximum time duration that the transmitting device supports phase continuity and power consistency may depend on one or more factors including XTAL accuracy.

In some embodiments, the information indicative of whether the transmitting device supports phase continuity during data transmission further indicates a maximum frequency hopping distance (e.g. in Hz). The maximum frequency hopping distance may depend on one or more factors including the supported bandwidth and the architecture of the transmitting device (e.g. UE architecture).

In some embodiments, the information indicative of whether the transmitting device supports phase continuity during data transmission further indicates whether the transmitting device supports intermittent transmission (i.e. transmission with time gaps), for example time division duplex (TDD) transmissions. It should be noted that intermittent transmission may be supported only when the time period between each intermittent transmission is sufficiently short (e.g. time gap between each transmission is equal or less than a few milliseconds (time gap <=X milliseconds)). It should be further noted that intermittent transmission can be supported substantially only when there is not a requirement for receiving data during this time gap. It should yet further be noted that intermittent transmission can be supported substantially only when the transmission power level is not adjusted during transmission.

In some embodiments, information indicative of whether the transmitting device supports phase continuity during data transmission further indicates whether phase continuity is supported for particular uplink (UL) data channels (e.g. physical uplink shared channel (PUSCH) or physical uplink control channel (PUCCH) or both).

According to some embodiments, a receiving device (e.g. BTS, gNB) can autonomously or independently determine whether a transmitting device supports phase continuity during data transmission. The receiving device (e.g. BTS, gNB) can estimate the channel (e.g., phase and amplitude of the channel) across multiple different slots using single-slot channel estimation. If the estimated channels across the multiple slots are similar to each other (e.g., phases and amplitudes of the estimated channels are similar), the receiving device will assume or determine that the transmitting device is able to maintain a constant phase (i.e. can support phase continuity) during multi-slot data transmission (i.e., while data is transmitted across multiple slots). The information indicative of the transmitting device's capabilities for supporting phase continuity during data transmission can be stored, for example, in the core network. Upon retrieval of this information by the receiving device from the core network, the receiving device (e.g., BTS, gNB) can determine whether or not the transmitting device can maintain the phase continuity for subsequent data transmissions.

According to embodiments, the receiving device autonomously or independently determines the transmitting device's capabilities for supporting phase continuity, this autonomous or independent determination is more feasible when transmission environments have a high signal to noise ratio (SNR) (e.g., in instances where the single-slot channel estimation can provide an accurate estimate). As such, the receiving device may only autonomously or independently determine a UE's or transmitting device's capabilities to support phase continuity when the transmitting device is in an area of cellular coverage of a sufficient quality, for example a cellular coverage area where the SNR is greater than approximately +3 dB.

According to some embodiments, a receiving device (e.g. BTS, gNB) determines whether a transmitting device (e.g. UE) supports phase continuity based on multiple channel estimations and their associated decoding. The receiving device can perform one or more of single-slot channel estimation and cross-slot channel estimation, and can decode the received data using one or more of single-slot estimation and cross-slot channel estimation.

In some embodiments, in order to minimize the additional computation required for multiple channel estimations and decoding, the receiving device can perform both single-slot estimation and cross-slot channel estimation only for the initial data transmission (or a few of the initial data transmissions). After the initial data transmission(s) (i.e. for subsequent data transmissions), the receiving device can perform either only single-slot channel estimation or only cross-slot channel estimation. The receiving device can determine whether to perform single-slot channel estimation or cross-slot channel estimation based on the accuracy of each channel estimation technique (i.e. accuracy of single-slot channel estimation vs. accuracy of cross-slot channel estimation), which may be determined during the initial data transmission. For example, the receiving device can base the decision on which type of channel estimation correctly decodes more often.

In some embodiments, the receiving device performs both single-slot channel estimation and cross-slot channel estimation (for example joint channel estimation) even after initial data transmission(s). In particular, if the receiving device (e.g. BTS, gNB) has capacity for extra computations (e.g. due to a lull in traffic), the receiving device can perform both single-slot estimation and cross-slot channel estimation and the associated decoding. In other words, after initial data transmission(s), the receiving device may perform single-slot channel estimation, cross-slot channel estimation (joint channel estimation) or combination thereof.

According to embodiments, performing multiple channel estimation techniques (i.e. performing both of the single-slot estimation and cross-slot channel estimation) can be reserved for use during circumstances where decoding transmissions from the transmitting device can be more challenging (e.g. when there is a low signal to noise ratio (SNR)). It should be noted that cross-slot channel estimation may have multiple sub-configurations (e.g. 2 slots, 4 slots, 8 slots).

As stated above, the phase continuity may not be maintained during a transmission if there is transmission power change or a timing adjustment (e.g. timing advanced or retarded), which occurs during the transmission. In other words, in order to maintain phase continuity during a transmission, the transmitting device should not adjust timing (e.g. no time advancing or retarding) or modify transmission power (e.g. no open loop power control). It is understood that this type of limitation may be restrictive in some cases or, at least, may not be beneficial. As such, embodiments of the present disclosure provide means to relieve this type of limitation, wherein the receiving device (e.g. BTS, gNB) notifies the transmitting device whether phase continuity is required or when phase continuity is expected to be maintained. In some embodiments, the receiving device further notifies the transmitting device of the desired time period when phase continuity is desired (i.e. time duration that the receiving device expects the phase to be continuous). In other words, the amount of time that the receiving device (e.g. gNB) expects the phase to be continuous can be signalled to the transmitting device (e.g. UE). In some embodiments, the notifications (e.g. notification for the time duration that the receiving device expects the phase to be continuous) are conveyed via radio resource control (RRC) signaling or in other embodiments is a more dynamic for example via a UL grant.

The methods for wireless communication with phase continuity according to embodiments, may improve the performance of a wireless communication system in terms of signal-to-noise ratio (SNR) gain (e.g. in the range of 1 to 3 dB) at low SNR (e.g. in bad cellular coverages). The improvement in SNR gain may provide performance improvement in terms of coverage (e.g. in the range of 1 to 3 dB), power saving (e.g. in the range of 25 to 100%) and/or spectral efficiency savings (e.g. in the range of 25 to 100%).

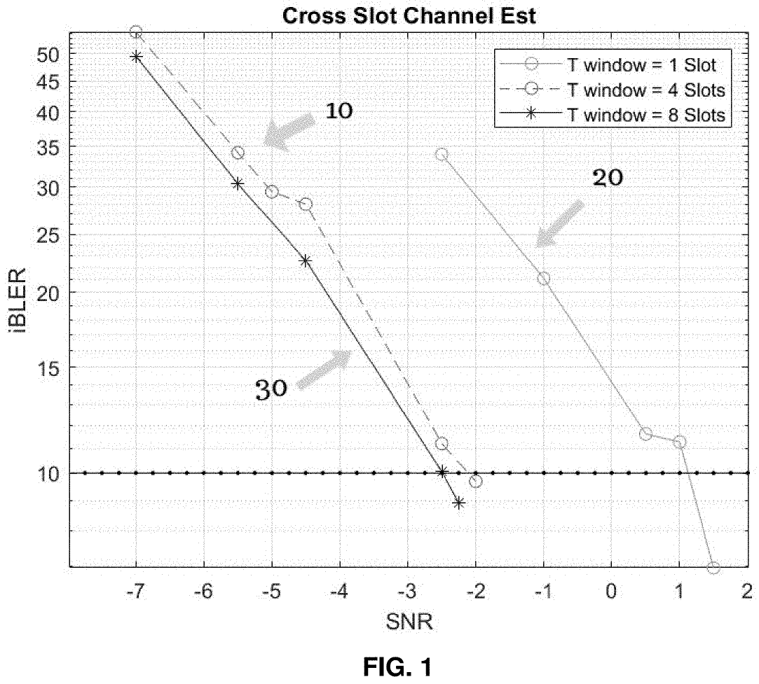

FIG. 1 illustrates error rates when transmitting transport blocks using cross-slot channel estimation under various signal-to-noise ratios (SNRs), in accordance with embodiments of the present disclosure. The results are obtained through a simulation by averaging pilots over slots, with 4 ms of time gap between each uplink slot. For this simulation, it is assumed that there are 6 physical resource blocks (PBRs), a transport block size (TBS) is 2200 bits, a Doppler frequency is 2 Hz, and there are 16 repetitions for each transport block transmission. Having regard to FIG. 1, error rates using cross-slot estimation over 1 slot 20, over 4 slots 10 and over 8 slots 30 are illustrated.

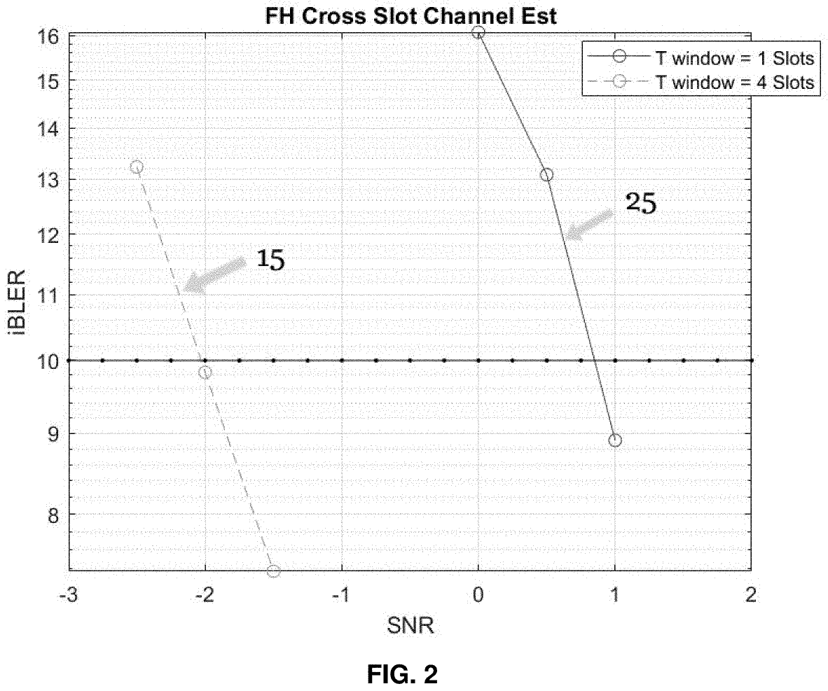

FIG. 2 illustrates error rates when transmitting transport block with frequency hopping using cross-slot channel estimation under various signal-to-noise ratios (SNRs), in accordance with embodiments of the present disclosure. The results are obtained through another simulation with frequency hopping. As illustrated in FIG. 2, a performance gain of approximately 2.75 dB can be obtained by averaging pilots over PUSCH transmissions of the same frequency. For this simulation, it is assumed that there are 6 PRBs, TBS is 888 bits, Doppler frequency is 2 Hz, and there are 8 repetitions for each transport block transmission. It is further assumed that there is no time gap between each uplink slot but there is a hopping interval of 1 ms (i.e. the frequency of transmission is altered for each slot). Having regard to FIG. 2, error rates using cross-slot estimation over 1 slot 25 and over 4 slots 15 are illustrated.

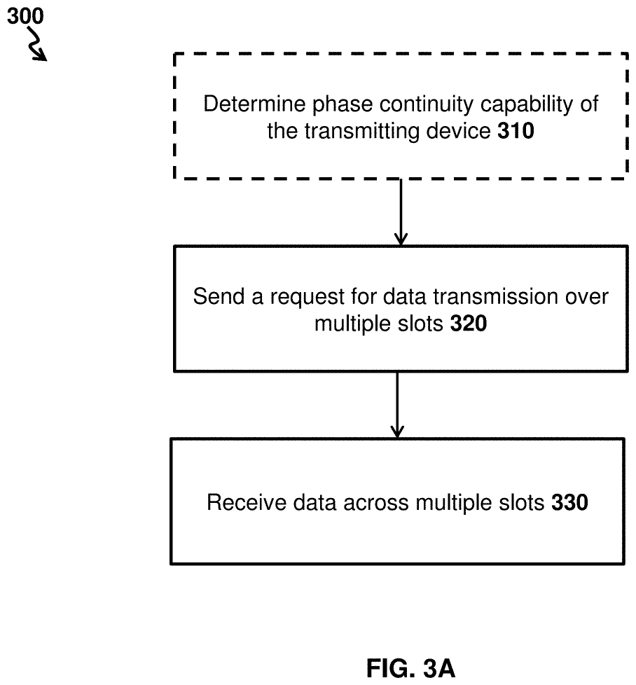

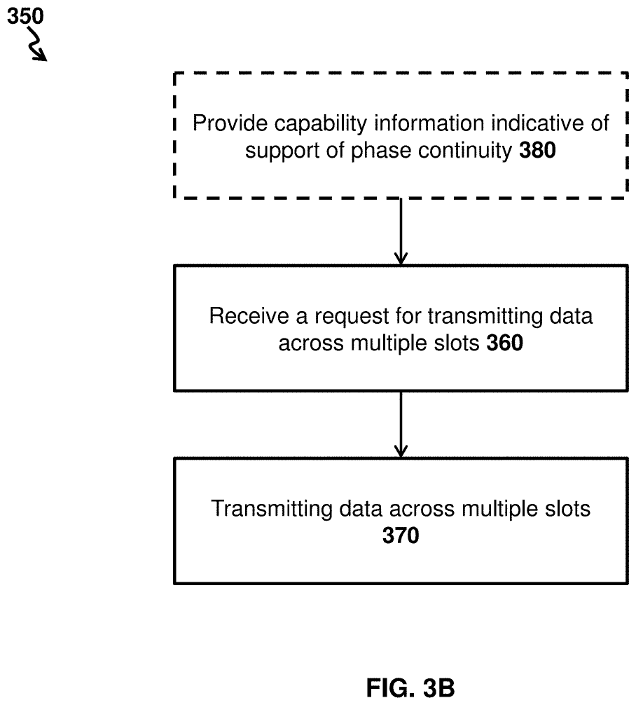

FIG. 3A illustrates a method for wireless communication with phase continuity, in accordance with embodiments of the present disclosure. With reference to FIG. 3A, the method 300 includes sending 320, by a receiving device to a transmitting device, a request for transmitting data across multiple slots with phase continuity. The method further includes receiving 330, by the receiving device from the transmitting device, the data across multiple slots, wherein the transmitting device maintains phase continuity while the data is transmitted. In some embodiments, the method optionally includes determining 310, by the receiving device, phase continuity capability of the transmitting device (i.e. if the transmitting device has the capability for supporting phase continuity during data transmission). In some embodiments, the receiving device may autonomously or independently determine phase continuity capability of the transmitting device. In some embodiments, the receiving device may determine phase continuity capability of the transmitting device at least in part based on one or more channel estimations performed by the receiving device across one or more slots using a single-slot channel estimation, a cross-slot channel estimation or both.

FIG. 3B illustrates a method for wireless communication with phase continuity, in accordance with embodiments of the present disclosure. With reference to FIG. 3B, the method 350 includes receiving 360, by a transmitting device from the receiving device, a request for transmitting data across multiple slots. The method further includes transmitting 370, by a transmitting device to the receiving device, the data across multiple slots, wherein the transmitting device maintains phase continuity while the data is transmitted. In some embodiments, the method optionally includes providing 380 capability information to the receiving device, capability information indicative of the transmitting device's support of phase continuity (i.e. whether the transmitting device supports or has capability to support phase continuity during data transmission).

In some embodiments, the method further includes refraining, by the transmitting device, from adjusting timing while transmitting the data. In some embodiments the method further includes refraining, by the transmitting device, from controlling transmission power while transmitting the data. In some embodiments, the method further includes receiving, by the transmitting device from the receiving device, a time duration that phase continuity is expected.

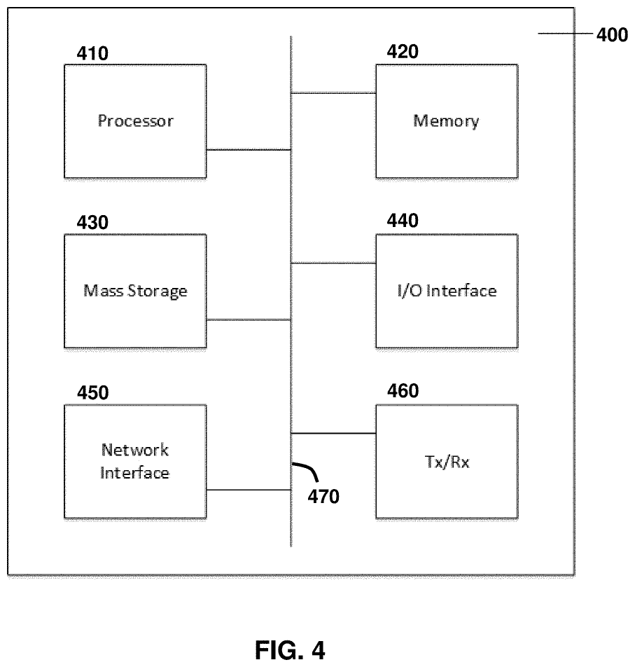

FIG. 4 is a schematic diagram of an electronic device 400 that may perform any or all of the steps of the above methods and features described herein, according to different embodiments of the present disclosure. For example, a user equipment (UE), base transceiver station (BTS), wireless gateway or mobility router may be configured as the electronic device. It may be noted that the “base transceiver station (BTS)” refer to an evolved NodeB (eNB), New Radio (NR) or next generation NodeB (gNodeB or gNB), a radio access node, or another device in a wireless communication network infrastructure, such as a long term evolution (LTE) infrastructure, which performs or directs at least some aspects of wireless communication with wireless communication devices. The “UE” refers to a device, such as a mobile device, machine-type-communication (MTC) device, machine-to-machine (M2M) equipment, or other device, which accesses the wireless communication network infrastructure via wireless communication with a base station.

As shown, the device includes a processor 410, memory 420, non-transitory mass storage 430, I/O interface 440, network interface 450, and a transceiver 460, all of which are communicatively coupled via bi-directional bus 470. According to certain embodiments, any or all of the depicted elements may be utilized, or only a subset of the elements. Further, the device 400 may contain multiple instances of certain elements, such as multiple processors, memories, or transceivers. Also, elements of the hardware device may be directly coupled to other elements without the bi-directional bus.

The memory 420 may include any type of non-transitory memory such as static random access memory (SRAM), dynamic random access memory (DRAM), synchronous DRAM (SDRAM), read-only memory (ROM), any combination of such, or the like. The mass storage element 430 may include any type of non-transitory storage device, such as a solid state drive, hard disk drive, a magnetic disk drive, an optical disk drive, USB drive, or any computer program product configured to store data and machine executable program code. According to certain embodiments, the memory 420 or mass storage 430 may have recorded thereon statements and instructions executable by the processor 410 for performing any of the aforementioned method steps described above.

As described above and elsewhere herein, some embodiments of the present disclosure provide a method and apparatus for wireless communication with phase continuity. In accordance with some embodiments of the present disclosure, there is provided a method for wireless communication with phase continuity. The method includes determining, by a transmitting device, if the transmitting device has a capability for supporting phase continuity during data transmission. Upon determination that the transmitting device supports phase continuity during data transmission, the method further includes receiving, by the transmitting device from a receiving device, a request for transmitting data across multiple slots. The method further includes transmitting, by the transmitting device to the receiving device, the data across multiple slots, wherein the transmitting device maintains phase continuity while the data is transmitted.

In some embodiments, the determination is performed by the transmitting device, the determination based on system configuration information, wherein the system configuration information includes one or more of duplexing information, frequency bands information, time division duplex (TDD) configuration, system bandwidth information and broadcast system information.

In some embodiments, the method further includes providing capability information to the receiving device when the transmitting device has a capability for supporting phase continuity during data transmission. In some embodiments, the capability information is provided to the receiving device during an initial access procedure. In some embodiments, the capability information is provided to the receiving device in message 5 of the initial access procedure. In some embodiments, the capability information is provided to the receiving device as a bit mask. In some embodiments, the capability information further indicates one or more of a maximum time that the transmitting device supports phase continuity, a maximum frequency hopping distance, whether intermittent data transmission is supported, whether phase continuity is supported for uplink (UL) data channels, and whether phase continuity is supported for UL control channels.

In some embodiments, during transmission of the data across multiple slots, the transmitting device refrains from adjusting one or more of phase, power, frequency and timing. In some embodiments, the transmitting device refrains from adjusting the power during transmission of the data and wherein the transmitting device maintains a phase and an amplitude during transmission of the data.

In some embodiments, the method further includes receiving, by the transmitting device from the receiving device, a request for transmitting the data with phase continuity. In some embodiments, the request for transmitting data with phase continuity is sent during higher layer signalling. In some embodiments, the request for transmitting data with phase continuity is sent via an uplink grant message.

In some embodiments, the method further includes receiving, by the transmitting device from the receiving device, a time duration that phase continuity is expected.

In accordance with some embodiments of the present disclosure, there is provided a method for wireless communication with phase continuity. The method includes receiving, by a transmitting device from a receiving device, a request for transmitting data across multiple slots. When the transmitting device supports phase continuity during data transmission, the method further includes transmitting, by the transmitting device to the receiving device, the data across multiple slots, wherein the transmitting device maintains phase continuity while the data is transmitted.

In some embodiments, the method further includes transmitting, by the transmitting device to the receiving device, information indicative of whether the transmitting device supports phase continuity during data transmission.

In some embodiments, during transmission of the data across multiple slots, the transmitting device refrains from adjusting one or more of phase, power, frequency and timing. In some embodiments, the transmitting device refrains from adjusting the power during transmission of the data and wherein the transmitting device maintains a phase and an amplitude during transmission of the data.

In accordance with some embodiments of the present disclosure, there is provided a transmitting device for wireless communication with phase continuity. The transmitting device includes a processor and machine readable memory storing machine executable instructions. The machine executable instructions, when executed by the processor configure the transmitting device to perform one or more of the above methods.

In accordance with some embodiments of the present disclosure, there is provided a method for wireless communication with phase continuity. The method includes determining, by a receiving device, if a transmitting device has a capability for supporting phase continuity during data transmission. Upon determination that the transmitting device supports phase continuity during data transmission, the method further includes sending, by the receiving device to the transmitting device, a request for transmitting data across multiple slots. The method further includes receiving, by the receiving device from the transmitting device, the data across multiple slots, wherein the transmitting device maintains phase continuity while the data is transmitted.

In some embodiments, determining if the transmitting device has the capability for supporting phase continuity during data transmission is determined autonomously by the receiving device. In some embodiments, determining if the transmitting device has the capability for supporting phase continuity is at least in part based on channel estimation performed by the receiving device across multiple slots using a single-slot channel estimation technique. In some embodiments, determining if the transmitting device has the capability for supporting phase continuity is at least in part based on multiple channel estimations performed by the receiving device, wherein the multiple channel estimations includes single-slot estimations and cross-slot channel estimations.

In accordance with some embodiments of the present disclosure, there is provided a receiving device for wireless communication with phase continuity. The receiving device includes a processor and machine readable memory storing machine executable instructions. The machine executable instructions, when executed by the processor configure the receiving device to perform the above method.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the disclosure are examples and can be varied in many ways. Such present or future variations are not to be regarded as a departure from the spirit and scope of the disclosure, and all such modifications as would be obvious to one skilled in the art are intended to be included within the scope of the following claims.

We claim:

1. A method for wireless communication with phase continuity, the method comprising:
receiving, by a transmitting device from a receiving device, a request for transmitting data across multiple slots with phase continuity; and
transmitting, by the transmitting device to the receiving device, the data across multiple slots, wherein the transmitting device maintains phase continuity while the data is transmitted.

2. The method according to claim 1, further comprising providing capability information to the receiving device, the capability information indicative of capability of the transmitting device for supporting phase continuity during data transmission.

3. The method accordingly to claim 2, wherein the capability information depends on system configuration information, wherein the system configuration information includes one or more of duplexing information, frequency bands information, time division duplex (TDD) configuration, system bandwidth information and broadcast system information.

4. The method according to claim 2, wherein the capability information is provided to the receiving device before transmitting the request for transmitting data across multiple slots with phase continuity.

5. The method according to claim 4, wherein the capability information is provided to the receiving device during an initial access procedure.

6. The method according to claim 2, wherein the capability information is provided to the receiving device as a bit mask.

7. The method according to claim 2, wherein the capability information further indicates one or more of:
a maximum time that the transmitting device supports phase continuity;
a maximum frequency hopping distance;
whether intermittent data transmission is supported;
whether phase continuity is supported for uplink (UL) data channels; and
whether phase continuity is supported for UL control channels.

8. The method according to claim 1, further comprising:
receiving, by the transmitting device from the receiving device, a time duration that phase continuity is expected.

9. The method according to claim 1, wherein during transmission of the data across multiple slots, the transmitting device refrains from adjusting one or more of phase, power, frequency and timing.

10. The method of claim 1, wherein the transmitting device maintains a phase and an amplitude during transmission of the data.

11. The method accordingly to claim 1, wherein the request for transmitting data with phase continuity is sent during higher layer signalling.

12. A transmitting device for wireless communication with phase continuity comprising:
a processor; and
machine readable memory storing machine executable instructions which when executed by the processor configure the transmitting device to:
receive, by a transmitting device from a receiving device, a request for transmitting data across multiple slots with phase continuity; and
transmit, by the transmitting device to the receiving device, the data across multiple slots, wherein the transmitting device maintains phase continuity while the data is transmitted.

13. The transmitting device according to claim 12, wherein the machine executable instructions when executed by the processor further configure the transmitting device to provide capability information to the receiving device, the capability information indicative of capability of the transmitting device for supporting phase continuity during data transmission.

14. The transmitting device according to claim 13, wherein the capability information depends on system configuration information, wherein the system configuration information includes one or more of duplexing information, frequency bands information, time division duplex (TDD) configuration, system bandwidth information and broadcast system information.

15. The transmitting device according to claim 13, wherein the capability information is provided to the receiving device before transmitting the request for transmitting data across multiple slots with phase continuity.

16. The transmitting device according to claim 12, wherein the machine executable instructions when executed by the processor further configure the transmitting device to receive, from the receiving device, a time duration that phase continuity is expected.

17. A method for wireless communication with phase continuity, the method comprising:
sending, by a receiving device to the transmitting device, a request for transmitting data across multiple slots with phase continuity; and
receiving, by the receiving device from the transmitting device, the data across multiple slots, wherein the transmitting device maintains phase continuity while the data is transmitted.

18. The method according to claim 17, further comprising: autonomously determining, by the receiving device, if the transmitting device has the capability for supporting phase continuity during data transmission.

19. The method according to claim 17, further comprising: determining, by the receiving device, if the transmitting device has the capability for supporting phase continuity during data transmission at least in part based on one or more channel estimations, the one or more channel estimations performed by the receiving device across one or more slots, the one or more channel estimations performed using one or more of single-slot channel estimation and cross-slot channel estimation.

20. A receiving device for wireless communication with phase continuity comprising:
a processor; and
machine readable memory storing machine executable instructions which when executed by the processor configure the receiving device to:
send, to the transmitting device, a request for transmitting data across multiple slots with phase continuity, and
receive, from the transmitting device, the data across multiple slots, wherein the transmitting device maintains phase continuity while the data is transmitted.
